(19) United States
(12) Patent Application Publication
(10) Pub. No.: US 2024/0411906 A1
(43) Pub. Date: Dec. 12, 2024

(54) CONFIDENTIAL CONFERENCING

(71) Applicant: Microsoft Technology Licensing, LLC, Redmond, WA (US)

(72) Inventor: Ryen W. WHITE, Woodinville, WA (US)

(73) Assignee: Microsoft Technology Licensing, LLC, Redmond, WA (US)

(21) Appl. No.: 18/207,452

(22) Filed: Jun. 8, 2023

(51) Int. Cl. G06F 21/62; G06V 10/70; G06V 20/40; H04L 12/18

(52) U.S. Cl. CPC G06F 21/62; G06V 10/70; G06V 20/41; H04L 12/1813

(57) ABSTRACT

Business and personal meetings are increasingly conducted virtually via video and/or audio conferencing. During such conferencing, participants can unwittingly leak private and/or confidential information with significant consequences for them and/or their employers. To prevent the disclosure of confidential content, one or more multimodal ML models are utilized by a conferencing service to detect and modify confidential content before, during, and/or after a live conferencing session. Content considered private or confidential to one individual or organization may be different than to another, so the models may be trained to recognize individual or organization-specific content. Furthermore, based on different user confidentiality levels, ML models may modify confidential content differently for different participants to a conferencing session.

### BACKGROUND

Business and personal meetings are increasingly conducted virtually via video and/or audio conferencing. During such conferencing, participants can unwittingly leak private and/or confidential information with significant consequences for them and/or their employers. For example, the contents of a whiteboard behind a video caller, an off-the-cuff remark made during a phone conversation, open windows or documents on a shared desktop, a shared slide deck, etc., can reveal trade secrets, private or embarrassing personal information or images, pending product announcements, etc. Moreover, when a conferencing session is recorded, such recordings may memorialize the confidential content and be shared far beyond the initial conference participants. Such inadvertent disclosures may result in irreparable harm to an organization or individual, reducing the practical utility of virtual conferencing platforms.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to detecting and modifying confidential content to avoid disclosure during a conferencing session. Virtual meetings are here to stay but, as so many have witnessed via viral videos, private personal information and/or other confidential information can be inadvertently and easily shared and then repeatedly reshared. Admittedly embarrassing but relatively benign, private content revealed during a conference session can include an unmuted toilet flush, pajama bottoms or boxer shorts caught on camera, or an inappropriate side-conversation on an open mic. In other examples, the consequences can be much more dire. For instance, a top-secret formula could be revealed on a whiteboard behind a video participant, credit card or bank account details could be visible on a participant's desk, or preliminary details of a product launch could be displayed via accidental screen sharing. These inadvertent disclosures can be even more devastating if participants record and reshare the conferencing session. In aspects, the technology disclosed herein detects and prevents disclosure of private and/or confidential content before, during, and/or after a conferencing session.

A conferencing session may include an audio and/or a video conference. During a conferencing session, various types of content may be actively or passively shared between participants. For instance, participants may share audio content via a microphone or speaker either actively (e.g., speaking, playing audio recordings, etc.) or passively (e.g., background sounds, music, side conversations, etc.). Additionally, participants of a video conferencing session may share visual content via a camera and/or screen sharing either actively (e.g., participant face, images, presentations, documents, video clips, etc.) or passively (e.g., participant background, unrelated desktop windows or documents). Moreover, all such shared content may be memorialized via audio or video recordings and shared far beyond the original participants. As should be appreciated, given the numerous ways in which audio or visual content can be intentionally or unintentionally shared during or after a conferencing session, the risk of inadvertent disclosures of confidential content is significant and the magnitude of potential harm is substantial—or even irreparable.

The present technology implements one or more multimodal ML models to detect and prevent disclosure of confidential content before, during, and/or after a live conferencing session. Content considered private or confidential to one individual or organization may be different than to another, so the models are trained to recognize individual or organization-specific content. As detailed above, since confidential content may be disclosed in different media formats, detecting confidential content may require different types of data extraction, processing, and/or evaluation. Moreover, once detected, preventing disclosure of confidential content in different media formats may implicate or require different modification protocols. During a live conferencing session, both the detection and modification of confidential content must occur in real time or near-real time. In some aspects, one multimodal ML model may be used to detect confidential content and another multimodal ML model may be used to modify the detected confidential content to prevent disclosure.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which one or more machine learning (ML) models may be used according to aspects of the present disclosure.

FIG. 2 illustrates an overview of an example conceptual diagram for using one or more ML models to detect and modify confidential content associated with a conferencing session according to aspects described herein.

FIGS. 3A-3D illustrate example use cases for detecting and modifying confidential content associated with a conferencing session according to aspects described herein.

FIG. 4A illustrates an overview of an example method for using one or more ML models to detect confidential content associated with a conferencing session according to aspects described herein.

FIG. 4B illustrates an overview of an example method for using one or more ML models to modify confidential content associated with a conferencing session according to aspects described herein.

FIG. 4C illustrates an overview of an example method for providing a cloaked conferencing session using one or more ML models to detect and/or modify confidential content associated with a conferencing session according to aspects described herein.

FIGS. 5A and 5B illustrate overviews of an example generative machine learning model that may be used according to aspects described herein.

FIG. 6 is a block diagram illustrating example physical components of a computing device with which aspects of the disclosure may be practiced.

FIG. 7 is a simplified block diagram of a computing device with which aspects of the present disclosure may be practiced.

FIG. 8 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As detailed above, business and personal meetings are increasingly conducted virtually via video and/or audio conferencing. During such conferencing, participants can unwittingly leak private and/or confidential information with significant consequences for them and/or their employers. For example, the content visible on a whiteboard behind a video caller, shared in an off-the-cuff remark made during a phone conversation, disclosed in unrelated windows or documents on a shared desktop, described in a shared slide deck, etc., can reveal trade secrets, private or embarrassing personal information or images, pending product announcements, and the like. Such inadvertent disclosures may result in irreparable harm to an organization or individual, reducing the practical utility and increasing the risk of using virtual conferencing platforms. Moreover, preventing such leaks or mitigating resultant damage causes increased enterprise exposure to data breaches, increases the need for organizational scrutiny of employee interactions, increases resource allocations to mitigate damage for leaked content, and the like.

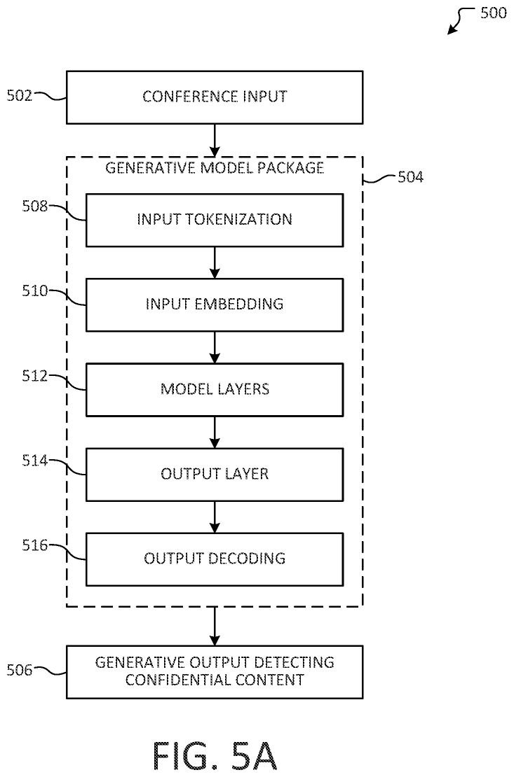

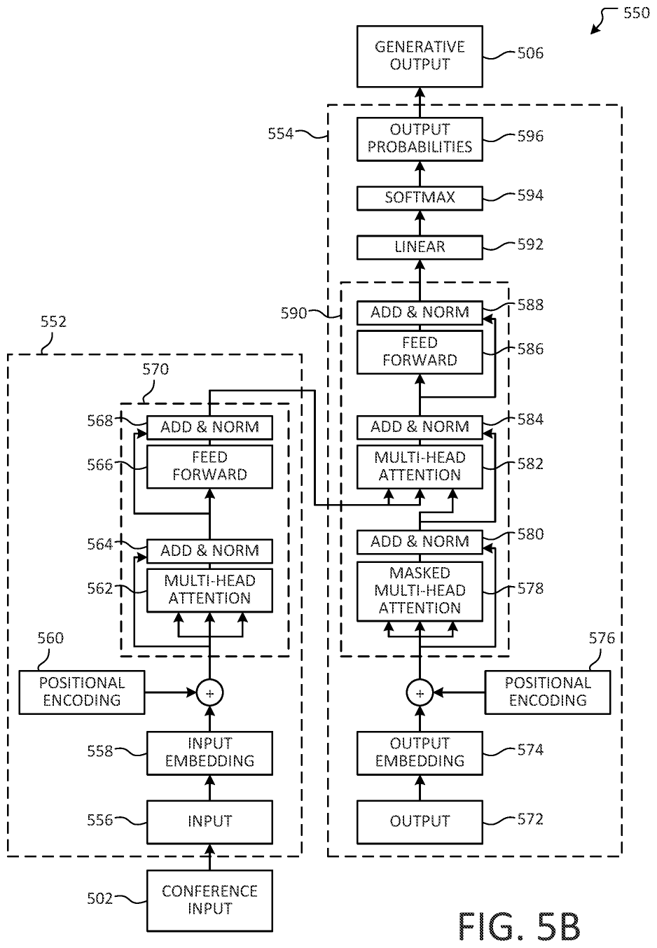

In examples, a generative model (also generally referred to herein as a type of machine learning (ML) model) may be used according to aspects described herein and may generate any of a variety of output types (and may thus be a multimodal generative model, in some examples). For example, the generative model may include a generative transformer model and/or a large language model (LLM), a generative image model, or the like. Example ML models include, but are not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 5A-5B.

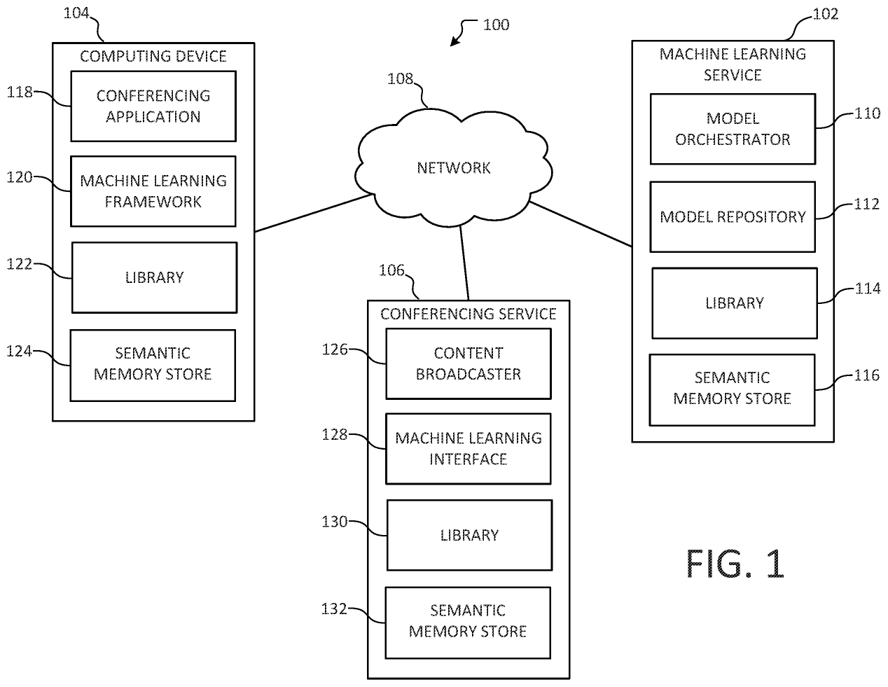

FIG. 1 illustrates an overview of an example system 100 in which one or more machine learning models may be used according to aspects of the present disclosure. As illustrated, system 100 includes machine learning service 102, computing device 104, conferencing service 106, and network 108. In examples, machine learning service 102, computing device 104, and conferencing service 106 communicate via network 108, which may comprise a local area network, a wireless network, or the Internet, or any combination thereof, among other examples.

As illustrated, machine learning service 102 includes model orchestrator 110, model repository 112, library 114, and semantic memory store 116. In examples, machine learning service 102 receives a request from computing device 104 (e.g., from machine learning framework 120) and/or from conferencing service 106 (e.g., from machine learning interface 128) to generate model output. As noted above, the request may include a conference input (e.g., audio and/or video input) generated by and/or received by conferencing application 118 or conferencing service 106. For example, confidential content may have an associated prompt template, which is used to generate a prompt (e.g., including input and/or context) that is processed using a corresponding ML model to generate model output accordingly. In other examples, an ML model associated with confidential content need not have an associated prompt template, as may be the case when prompting is not used by the ML model when processing input to generate model output.

The received request is processed by model orchestrator 110, which may identify one or more ML models from model repository 112 and process the conference input accordingly. In an example, model orchestrator 110 processes the request to generate the model output (e.g., using one or more models of model repository 112), which model output may include detecting confidential content or modifying detected confidential content associated with the conference input.

In an example, model orchestrator 110 may generate two model outputs (e.g., a first model output and a second model output) using a generative ML model, library 114, and/or context from semantic memory store 116. Model orchestrator 110 may process at least a part of the conference input to detect confidential content therein and a first model output may comprise an indication of the detected confidential content in the conference input. Model orchestrator 110 may further process the detected confidential content (e.g., first model output) using one or more models of model repository 112, library 114, and/or context from semantic memory store 116 to modify the detected confidential content to generate a second model output. Based on the type of detected confidential content (e.g., audio and/or visual), model orchestrator 110 may generate and apply different techniques for modifying or obscuring (e.g., blurring, deleting, rewriting, overwriting, infilling, and the like) the detected confidential content to generate the second model output. For example, by obscuring the content, the detected confidential content may be cloaked (e.g., redacted, concealed, etc.) to prevent disclosure. Based on the second model output, the conferencing application 118 and/or the conferencing service 106 may broadcast a modified conference output (e.g., cloaked audio and/or video output) that obscures the confidential content.

In another example, model orchestrator 110 may generate one model output using a first ML model, library 114, and/or context from semantic memory store 116. Model orchestrator 110 may process at least a part of the conference input to detect confidential content therein and the model output may comprise an indication of the detected confidential content in the conference input. Based on the model output, the conferencing application 118 and/or the conferencing service 106 may automatically apply a modification (e.g., blurring, redacting, rewriting, overwriting, infilling, and the like) to the conference input to obscure the detected confidential content and prevent disclosure thereof. In some aspects, the modification applied by the conferencing application 118 and/or the conferencing service 106 may be generalized for a type of content (e.g., audio or video). That is, for audio content, audio data associated with the detected confidential content may be obscured by lowering the audible volume of the sound (e.g., muting a spoken term or the sound of a toilet flush) or by replacing it with another sound (e.g., another term or phrase generated by AI, a beep, a bell, or the like). For video content, image data associated with the detected confidential content may be obscured by blurring or deleting, for example. Thereafter, conferencing application 118 and/or conferencing service 106 may broadcast a modified conference output (e.g., cloaked audio and/or video output) that obscures the detected confidential content. In aspects, more advanced techniques for modifying the detected confidential content (e.g., overwriting, infilling, splicing audio or video, and the like) may be determined and applied by model orchestrator 110 using a second ML model to generate a second model output.

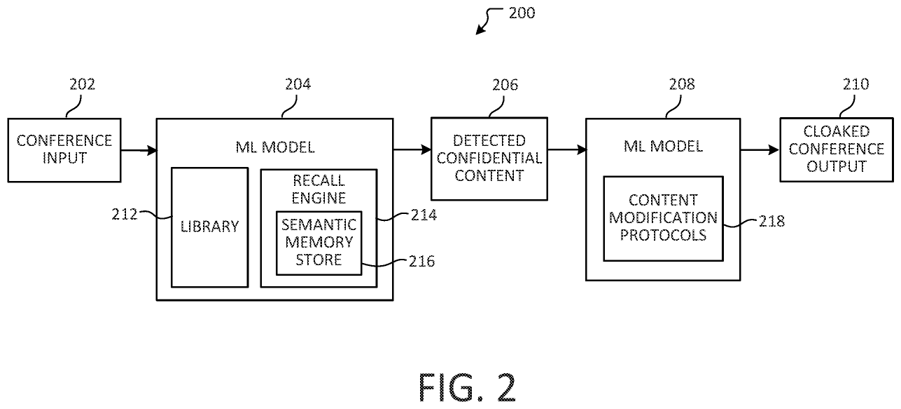

In another example, the request includes a context with which the request is to be processed (e.g., from semantic memory store 124 of computing device 104 or semantic memory store 132 of conferencing service 106). As a further example, the request includes an indication of context in semantic memory store 116, such that model orchestrator 110 obtains the context from semantic memory store 116 accordingly. Additional examples of these and other aspects are discussed below with respect to semantic memory store 216 and corresponding recall engine 214 in FIG. 2. Such aspects may be used in instances where machine learning framework 120 and/or machine learning interface 128 perform aspects similar to model orchestrator 110, such that machine learning framework 120 and/or machine learning interface 128 detect and/or modify confidential content in a conference input and/or manage processing of the conference input accordingly.

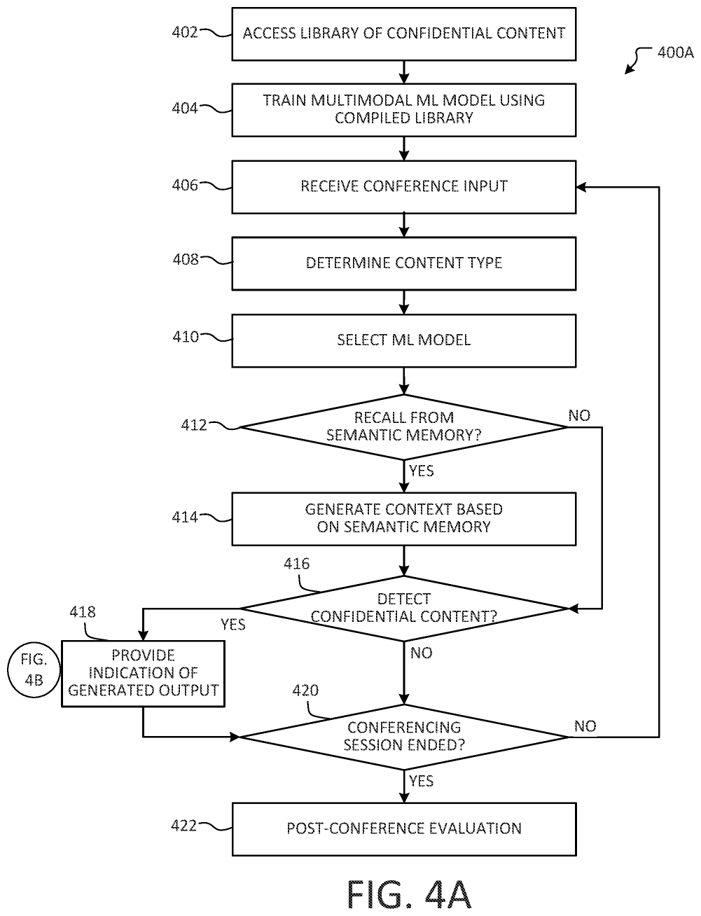

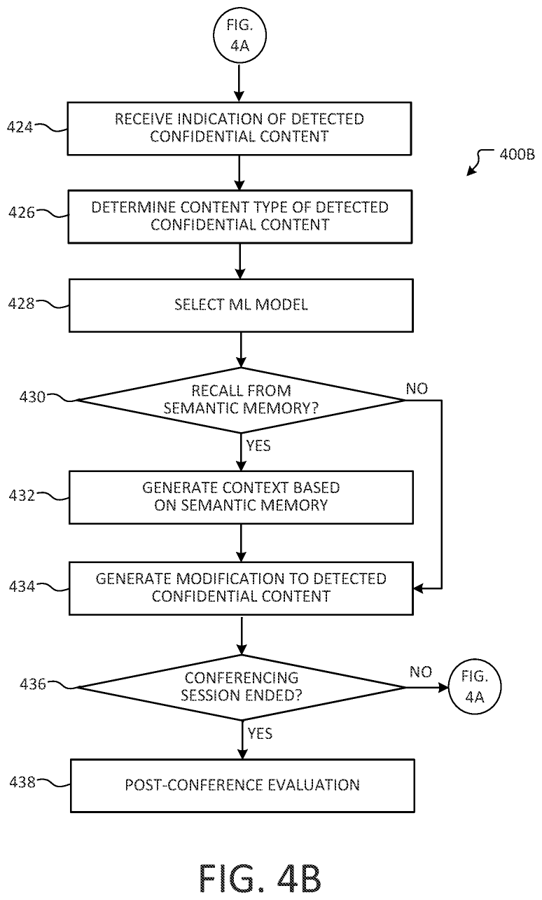

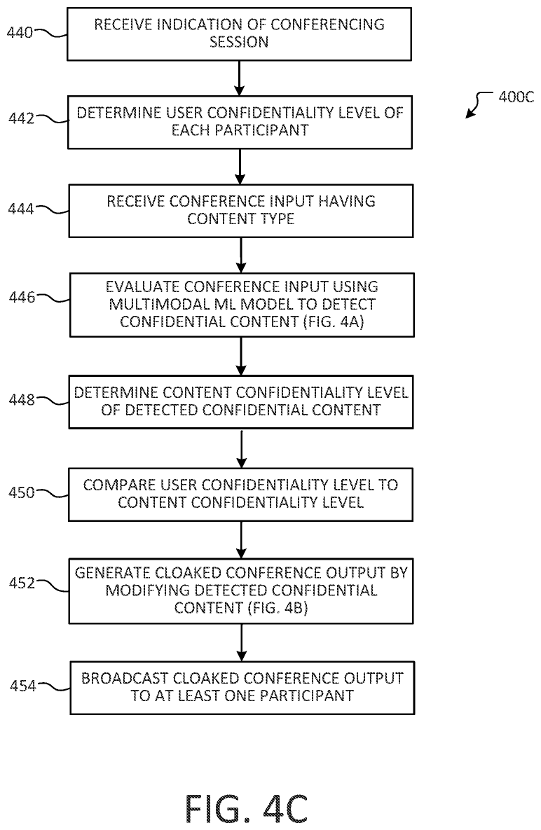

In some instances, model orchestrator 110 obtains additional information that is used when processing a request (e.g., as may be obtained from a remote data source or as may be requested from a user of computing device 104). For instance, model orchestrator 110 may determine to obtain additional information for a given evaluation of a conference input, among other examples. As an example, additional information may be obtained from a remote library (not shown) (e.g., as opposed to library 114, library 122, and/or library 130). Examples of such aspects are discussed in greater detail below with respect to method 400A-B of FIGS. 4A-4B, respectively.

Model repository 112 may include any number of different ML models. For example, model repository 112 may include foundation models, language models, speech models, video models, and/or audio models. As used herein, a foundation model is a model that is pre-trained on broad data that can be adapted to a wide range of tasks (e.g., models capable of processing various different tasks or modalities). In examples, a multimodal machine learning model of model repository 112 may have been trained using training data having a plurality of content types. Thus, given content of a first type, an ML model of model repository 112 may generate content having any of a variety of associated types. It will be appreciated that model repository 112 may include a foundation model as well as a model that has been finetuned (e.g., for a specific context and/or a specific user or set of users), among other examples.

Turning now to computing device 104, computing device 104 includes conferencing application 118, machine learning framework 120, skill library 122, and semantic memory store 124. In examples, conferencing application 118 uses machine learning framework 120 to process conference input and generate model output accordingly, which may be presented to a user of computing device 104 and/or used for subsequent processing by conferencing application 118, among other examples.

In examples, aspects of machine learning framework 120 and machine learning interface 128 are similar to model orchestrator 110 and are therefore not necessarily redescribed in detail. For example, in addition to or as an alternative to confidential content detection and/or confidential content modification by model orchestrator 110, machine learning framework 120 and/or machine learning interface 128 may detect and/or modify confidential content in a conference input according to aspects described herein. For example, machine learning framework 120 and/or machine learning interface 128 provides an indication of the conference input to machine learning service 102, such that an indication of detected confidential content and/or an indication of a modification to detected confidential content is generated by machine learning service 102 and is received by computing device 104 and/or conferencing service 106 in response. Accordingly, machine learning framework 120 and/or machine learning interface 128 manages the evaluation of the conference input (e.g., generating subsequent requests to machine learning service 102 for subsequent detection and/or modification of confidential content) according to pre-designated samples of confidential content (e.g., as may be stored in library 114/122/130) and/or based on associated context (e.g., from semantic memory store 116/124/132). In examples, machine learning framework 120 and/or machine learning interface 128 request model output from machine learning service 102 for detecting confidential content associated with one or more conference inputs, while detected confidential content may be processed (e.g., modified) local to (or, in other examples, remote from) computing device 104 and/or conferencing service 106. In additional or alternative examples, machine learning framework 120 and/or machine learning interface 128 request model output from machine learning service 102 for detecting and modifying confidential content associated with one or more conference inputs.

It will therefore be appreciated that the disclosed aspects may be implemented according to any of a variety of paradigms. For example, confidential content detection and/or modification may be performed client side (e.g., machine learning framework 120), server side (e.g., by model orchestrator 110), third-party service side (e.g., machine learning interface 128) or any combination thereof, among other examples. For instance, model orchestrator 110 may perform a first ML evaluation associated with a conference input to provide a model output (e.g., indication of detected confidential content), while a second ML evaluation is performed by machine learning framework 120 and/or machine learning interface 128 based on the model output (e.g., modification of the detected confidential content). Machine learning framework 120 may be provided as part of an operating system of computing device 104 (e.g., as a service, an application programming interface (API), and/or a framework), may be made available as a library that is included with conferencing application 118 (or may be more directly incorporated by an application), or may be provided as a standalone application, among other examples. Machine learning interface 128 may be provided as part of a service of conferencing service 106 (e.g., as an application programming interface (API)) or may be made available as a library (e.g., library 130) that is included with conferencing service 106, among other examples.

As another example, a user interface is provided to computing device 104 via which a user may interact with machine learning framework 120, machine learning interface 128 and/or model orchestrator 110. For example, machine learning framework 120 and/or machine learning interface 128 may additionally, or alternatively, implement aspects similar to machine learning service 102, such that machine learning service 102 provides a website via which a user may interact with a console or terminal interface of the machine learning service 102 accordingly. The console may include a text-based user interface via which a user may designate or upload examples of confidential content for a particular user or enterprise. In other aspects, a user may designate a location (e.g., file location) for obtaining examples of confidential content. Such examples may include, without limitation, terms (e.g., previous project names, naming conventions associated with confidential projects, organizational confidentiality levels or designations, footer designations of confidentiality), VIP user names or aliases (e.g., CEO, general counsel, human resources employees, or other company officials associated with confidential content), user confidentiality levels (e.g., organizational low, medium, high, VIP levels, etc.), documents (e.g., pre-launch product specifications, internal presentations, whitepapers), metadata (e.g., file names/titles, authors, file extensions, file types, descriptions, etc., associated with confidential content), images (e.g., blueprints, product prototypes, maps, graphics, diagrams, reports), spreadsheets (e.g., financials, experimental data), links or pointers (e.g., file locations associated with repositories of confidential content), sounds (e.g., spoken terms, names, jingles), and the like, that may be used to train one or more ML models for detecting confidential content specific to an organization or individual. As should be appreciated, confidential content may be designated via any suitable means and the foregoing list is provided for purposes of example and should not be considered as limiting in any way. Such indications of custom confidential content may be stored or associated with library 114/122/130 or otherwise accessible to machine learning service 102, machine learning framework 120, and/or machine learning interface 128, respectively.

As a further example, computing device 104 may include a user interface that is part of an application (e.g., conferencing application 118) or a plurality of applications (e.g., as a shared framework or as functionality that is provided by an operating system of computing device 104). In such an example, natural language input may be provided via the user interface (e.g., as text input and/or as voice input), which may be processed according to aspects described herein and used to detect and/or modify confidential content in a conference input accordingly. For example, the operating system may provide a command interface via which interactions may be performed, for example through an accessibility API and/or an extensibility API.

FIG. 2 illustrates an overview of an example conceptual diagram for using one or more ML models to detect and modify confidential content associated with a conferencing session according to aspects described herein. As illustrated, diagram 200 processes conference input 202 according to a set of models (e.g., ML models 204 and 208, as orchestrated by a model orchestrator (e.g., model orchestrator 110) to generate first model output (e.g., detected confidential content 206 in conference input 202). For example, conference input 202 may be received from a computing device, such as computing device 104, or a conferencing service, such as conferencing service 102, of FIG. 1.

Conference input 202 (e.g., audio or visual input) may be accompanied by request input, which may include any of a variety of input formats, including, but not limited to, natural language, command-line, input that is received via a framework or an application, and/or input that is received via a central service (e.g., of an operating system) or a uniform resource identifier (URI) handler, among other examples. While examples are described herein with reference to natural language input, it will be appreciated that any of a variety of additional or input types may be received, including, but not limited to, image input and/or video input. Further, natural input may include any of a variety of input, such as text input or speech input.

As illustrated, conference input 202 is processed by ML model 204 and ML model 208 to ultimately generate second model output (e.g., modified confidential content associated with cloaked conference output 210) according to aspects described herein. Such aspects may be similar to those discussed above with respect to model orchestrator 110, such that conference input 202 is processed to detect and/or modify confidential content for ultimate output as cloaked conference output 210.

In examples, library 212 is dynamically generated and updated. As an example, library 212 may include one or more files that each define designated types or examples of confidential content with which conference input 202 may be processed. As another example, library 212 includes a database that stores a listing or indications of confidential content, which may be specific to an individual user or organization. Confidentiality levels associated with users (e.g., employees of an organization) may also be stored in library 212. In some instances, a new example of confidential content may be registered (e.g., in the database or in an index), thereby indicating that the example is available for use in processing conference input 202. In aspects, designated confidential content (e.g., stored in library 212) may be associated with a level of confidentiality, such as low, medium, high, top-secret. In this case, a level of detected confidential content may be evaluated against a level of confidentiality associated with each participant of a conferencing session. Based on corresponding confidentiality levels, detected confidential content may be obscured for some participants and not for others. Detected confidential content 206 may automatically be added to library 212 for evaluation of subsequent conference input 202.

Moreover, a conferencing application (e.g., conferencing application 118) and/or conferencing service (e.g., conferencing service 106) may be programmed to include indications of generic confidential content that are registered within library 212. For example, some terms (e.g., “confidential,” “proprietary,” “attorney eyes only,” “do not forward”), number formatting (e.g., indicative of Social Security Numbers, Driver's License Numbers, phone numbers), file extensions (e.g., “.dwg” for AutoCAD; “.stl,” “.obj,” “.fbx,” “.dae” for 3D printing; “.mat” for MATLAB; “.cdx” for ChemDraw), mathematical conventions (e.g., terms, symbols, format), code languages (e.g., XML, C++, JavaScript®, Python®), and the like, may be indicative of files or documents containing confidential content. In other cases, some terms, images, or sounds may generally be considered inappropriate, offensive, private, or embarrassing (e.g., sound of a toilet flushing, sound of belching, sound of an automobile horn, images of private body parts, curse words, pejorative terms, derogatory terms, offensive terms) such that processing of conference input 202 by a conferencing application and/or conferencing service may be performed generally (rather than specifically for an individual or organization) according to aspects described herein. It will therefore be appreciated that indications of confidential content may be stored in library 212 using any of a variety of techniques.

As illustrated, conference input 202 is processed by ML model 204 to generate intermediate output. In examples, the intermediate output comprises structured output, which may include one or more tags, key/value pairs, and/or metadata, among other examples. For example, a stream may be denoted according to an associated tag within such structured output. In examples, a prompt template defines or otherwise includes an indication relating to such structured output, thereby causing the generative ML model to produce structured output accordingly. As such, use of structured output may increase the degree to which model output is deterministic and may therefore improve reliability according to aspects described herein. In other examples, intermediate output may be similar to ultimate model output that may otherwise be provided for further processing by an application, e.g., a conferencing application, among other examples. In some aspects, intermediate output from ML model 204 is then processed by ML model 208 to modify the detected confidential content 206, thereby generating cloaked conference output 210. ML models 204 and 208 may each be the same or a similar model (e.g., generating the same content type(s) and/or trained using similar training data) or, as another example, ML models 204 and 208 may each be different models (e.g., generating different sets of content types).

As noted above, conference input may include or otherwise be associated with a prompt template. One or more fields, regions, and/or other parts of the prompt template may be populated (e.g., with input and/or context), thereby generating a prompt to be processed by an ML model according to aspects described herein. For instance, the prompt is used to prime the ML model, thereby inducing the model to generate output corresponding to the prompt template. It will be appreciated that a prompt template may include any of a variety of data, including, but not limited to, natural language, image data, audio data, video data, and/or binary data, among other examples. In some examples, prompt templates associated with different content types/formats of conference input may be stored in library 212.

Thus, in examples, input as used herein invokes processing by an ML model (e.g., according to an associated prompt template) to process a given conferment input (e.g., as may be received from a user or as may be intermediate output). In examples, context is processed as part of the ML model evaluation. For example, an input may include an indication as to context or define a context that is provided to the ML model, and/or a chain orchestrator (e.g., that defines and/or manages processing of conference input) may determine context that is used for ML model evaluation accordingly, among other examples.

In examples, ML model 204 may use context obtained from recall engine 214, as may be stored by semantic memory store 216. For example, it may be determined (e.g., by a model orchestrator and/or by ML model 204) that processing associated with a conference input 202 should be performed according to context from recall engine 214. In other examples, library 212 may indicate that context should be obtained from semantic memory store 216, such that recall engine 214 is used to obtain such context accordingly. While ML model 208 is not shown having a recall engine 214 and/or semantic memory store 216, ML model 208 may similarly process detected confidential content 206 using semantic embeddings, as described below.

As an example, semantic memory store 216 stores semantic embeddings (also referred to herein as “semantic addresses”) associated with ML model 204, which may correspond to one or more content objects. In examples, an entry in semantic memory store 216 includes one or more semantic embeddings corresponding to a context object itself or a reference to the context object, among other examples. In examples, semantic memory store 216 stores embeddings that are associated with one or more models (e.g., ML model 204 and/or 208) and their specific versions, which may thus represent the same or similar content but in varying semantic embedding spaces (e.g., as is associated with each model/version). Further, when a new model is added or an existing model is updated, one or more entries within semantic memory store 216 may be reencoded (e.g., by generating a new semantic embedding according to the new embedding space). In this manner, a single content object entry within semantic memory store 216 may have a locatable semantic address across models/versions, thereby enabling retrieval of content objects based on a similarity determination (e.g., as a result of an algorithmic comparison) between a corresponding semantic address and a semantic context indication.

As a result, an input embedding may be generated (e.g., as may be associated with conference input 202 and/or processing by ML model 204 or 208). For example, the input embedding may be generated by a machine learning model based on any of a variety of conference input 202 (e.g., audio and/or visual input) that is received by a computer. Additional and/or alternative methods for generating an input embedding may be recognized by those of skill in the art.

Recall engine 214 may thus identify one or more content objects that are provided as context for processing associated with detecting confidential content in a conference input based on the input embedding. For example, a set of semantic embeddings that match the input embedding (e.g., using cosine distance, another geometric n-dimensional distance function, or other algorithmic similarity metric) may be identified and used to identify one or more corresponding content objects accordingly. As noted above, processing by ML model 204 and/or ML model 208 may add, remove, or otherwise modify one or more entries of semantic memory store 216, such that context from recall engine 214 that is used for processing a subsequent conference input may be affected by one or more previous indications of detected confidential content.

As noted above, in some aspects, ML model 208 may process intermediate output (e.g., detected confidential content 206) so as to modify the intermediate output to prevent disclosure of the detected confidential content 206, thereby generating cloaked conference output 210. In aspects, ML model 208 may utilize one or more content modification protocols to modify the detected confidential content 206. For instance, ML model 208 may utilize a different one of a plurality of content modification protocols 218 based on a content type (e.g., audio, video, image, digital text, and the like) associated with the detected confidential content 206. For example, if the detected confidential content 206 is an image, a first content modification protocol may be utilized to obscure the detected confidential content 206 in associated image data, such as by blurring, pixelating, infilling, rewriting, and the like. In another example, if the detected confidential content 206 is audio content, a second content modification protocol may be utilized to mute, overwrite, or otherwise remove sound waves associated with the detected confidential content 206.

In some aspects, the ML model 208 may be trained to obscure the detected confidential content 206 such that participants to a conferencing session may not be aware of the modification (e.g., such as a slight aberration in a video feed, a slight pause in an audio feed, or an infilling of a detected confidential portion of an image). In other aspects, ML model 208 may be trained to apply an obfuscation that may alert participants to a change (e.g., blurring, redaction). In further aspects, ML model 208 may be trained to preemptively notify a participant of detected confidential content 206 prior to the participant sharing the information. For example, conferencing application 118 and/or conferencing service 106 may analyze a preview of a participant and the participant's background prior to the participant joining the call. In this way, the participant may be alerted to cover or remove detected confidential content prior to joining the call.

In some examples, based on user confidentiality levels, ML model 208 may be trained to obscure the detected confidential content 206 for a first participant (e.g., based on a first user confidentiality level being lower than a content confidentiality level associated with the detected confidential content 206) and not for a second participant (e.g., based on a second user confidentiality level being higher than the confidentiality level associated with the detected confidential content 206. In other examples, detected confidential content 206 may be modified globally for all participants based on the lowest user confidentiality level represented by a participant in the conference session. In this way, the detected confidential content 206 is not disclosed to the first participant while being disclosed to the second participant of the conferencing session.

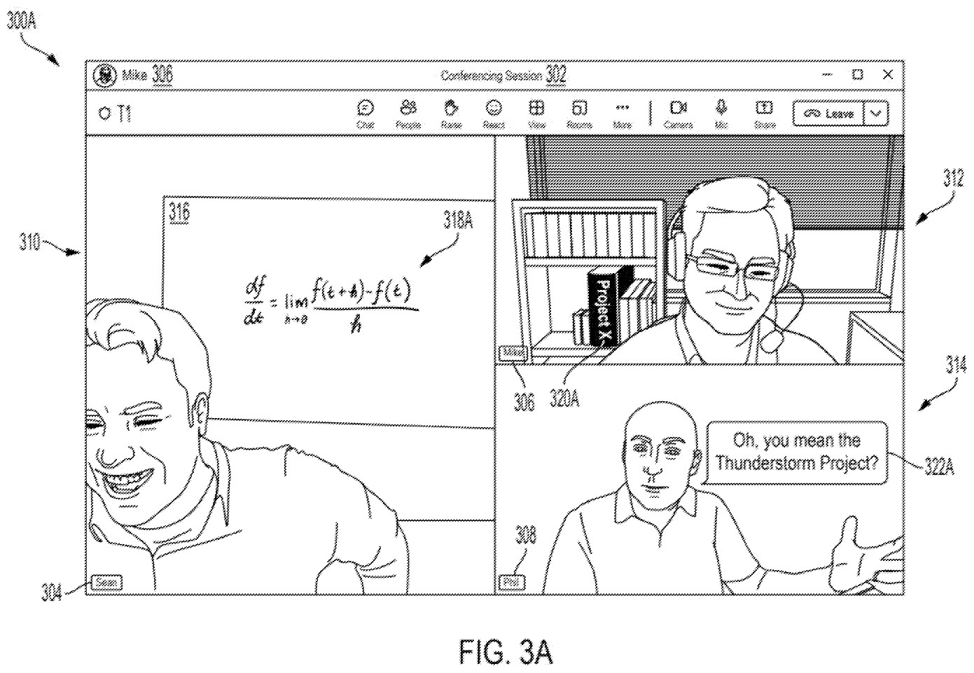

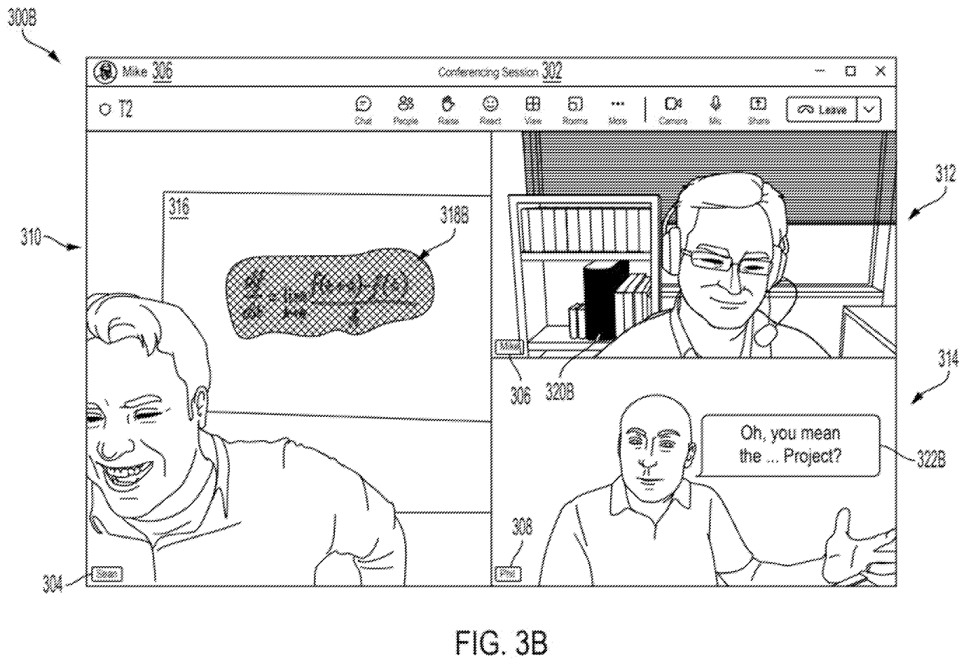

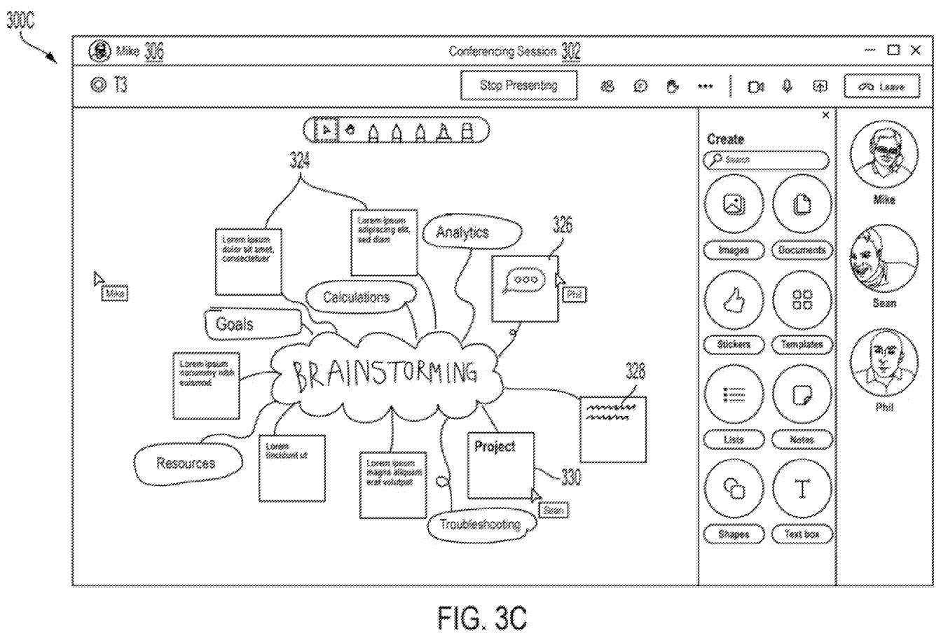

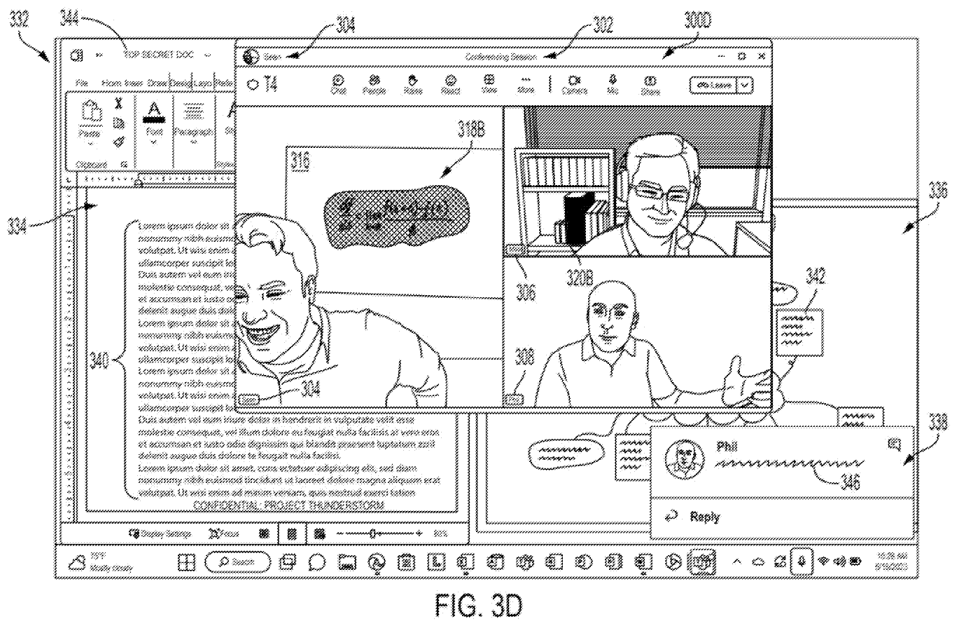

FIGS. 3A-3D illustrate example use cases for detecting and modifying confidential content associated with a conferencing session according to aspects described herein.

FIG. 3A depicts a user interface 300A hosted by a conferencing application (e.g., conferencing application 118 of FIG. 1) running on a computing device (e.g., computing device 104) associated with a second participant 306 (“Mike”) attending a video conferencing session 302. User interface 300A displays at least one frame of conferencing session 302 at time T1. As shown, first participant 304 (“Sean”) is displayed in first pane 310 of the user interface 300A, second participant 306 (“Mike”) is displayed in second pane 312 of the user interface 300A, and third participant 308 (“Phil”) is displayed in third pane 314 of the user interface 300A. As further illustrated by FIG. 3A, a mathematical formula 318A is visible on a whiteboard 316 behind the first participant 304 in first pane 310. The title 320A of a book, “Project X,” is visible behind the second participant 306 in second pane 312. Additionally, the spoken text 322A of third participant 308 states, “Oh, you mean the Thunderstorm Project?”

FIG. 3B depicts a user interface 300B of conferencing session 302 at time T2. In aspects, T2 may appear to the participants to be substantially simultaneous to time T1. That is, the participants to the conferencing session 302 may detect an imperceptible or nearly imperceptible time difference between time T1 and time T2. In this case, according to aspects described herein, a conference input representing the at least one frame of the conferencing session 302 at time T1 is processed in real-time by a multimodal ML model to detect whether confidential content is being disclosed during the conferencing session 302. As described above, each of the participants may be associated with a user confidentiality level. Since user interface 300B is displayed to the second participant 306, the one or more ML models may detect whether second participant 306 is authorized to view all of the content represented by the at least one frame of conferencing session 302. For example, the one or more ML models may detect various types of content in the at least one frame (e.g., image content, audio content, textual content, etc.) that may be associated with confidential content, e.g., the mathematical formula 318A on whiteboard 316, the title 320A of the book in pane 312, and the spoken text 322A uttered by the third participant 308.

Based on the confidentiality level of the second participant 306, it may be determined that the second participant 306 is not authorized to view or hear such content. In this case, the same or another multimodal ML model may apply an appropriate modification to the detected confidential content to prevent disclosure of the content to the second participant 306. As illustrated, the mathematical formula 318B has been blurred to prevent disclosure. In other aspects, mathematical formula 318A may be redacted entirely from whiteboard 316 (not shown). Further, the title 320B of the book has been redacted and infilled to blend with the book binding. In other aspects, the title 320A may be blurred or otherwise obscured to prevent disclosure. As further illustrated, the spoken text 322A uttered by the third participant 306 has been modified to eliminate the term “Thunderstorm,” such that the spoken text 322B transmitted to the second participant 306 comprises, “Oh, you mean the . . . project?” In aspects, the term “Thunderstorm” may be replaced by a slight pause or a beep, for instance (represented by the ellipsis). If the term is muted resulting in a slight pause, the second participant 306 may be unaware of the deletion of the term; whereas if the term is replaced by another sound (e.g., a beep or bell), the second participant 306 may be aware of the deletion of the term. In some aspects, if the second participant 306 records the conferencing session, the content captured by the recording may correspond to the content authorized for viewing by the second participant 306 during the conferencing session. In other aspects, a recording of a conferencing session may be evaluated retrospectively. That is, the recording may be analyzed based on a user confidentiality level associated with a recipient of the forwarded recording rather than the participant of the meeting who recorded it. In this way, when a recipient has a lower confidentiality level than the participant who recorded the meeting, the multimodal ML model may be triggered to further modify detected confidential content in the recording to prevent disclosure to the recipient. In aspects, the multimodal ML model may apply modifications to either an original unmodified recording or to a modified copy.

As should be appreciated, one or more ML models may evaluate content shared during the conferencing session 302 for each participant. Based on the confidentiality levels of the first and third participants, for example, more or less content may be identified as confidential content. That is, some content that is detected as confidential content and modified to prevent disclosure to one participant may not be identified as confidential content and/or modified for another participant and vice versa. Thus, for participants having different confidentiality levels, the user experience during a conferencing session 302 may differ to ensure that confidential content is not disclosed to those without adequate permissions. In aspects, the modifications made to detected confidential content described above are provided as examples and should not be understood as limitations to the described technology.

FIG. 3C depicts a user interface 300C of conferencing session 302 at time T3. As illustrated, a brainstorming session is being conducted by the participants during the conferencing session 302. As will be appreciated, based on the confidentiality level of the second participant 306, at least some content shared by the first participant 304 and the third participant 308 during the brainstorming session may not be available to the second participant 306. For example, text boxes 324 have been overwritten with pseudo text to obscure confidential content from disclosure to the second participant 306. Similarly, text box 328 has been overwritten with wavy lines to obscure confidential content from disclosure to the second participant 306. In some aspects, as the third participant 308 (“Phil”) is typing content into text box 326, the text may be reflected by thinking bubbles until confirmation that the text can be disclosed to the second participant 306. In still other examples, text box 330 entered by first participant (“Sean”) has been rewritten from “the Thunderstorm Project” (not shown) to “Project” to prevent disclosure of a project name to the second participant 306.

FIG. 3D represents a screenshare of desktop 332 at time T4. In this example, the first participant 304 (“Sean”) has inadvertently shared his desktop 332 to the participants of the conferencing session 302. Continuing from the perspective of the second participant 306, mathematical formula 318B and title 320B within the user interface 300D shared by the first participant 304 are not viewable by the second participant 306. However, in this case, additional content associated with the desktop 332 of the first participant 304 is processed in real-time by a multimodal ML model to detect various types of content associated with the desktop 332 (e.g., image content, audio content, textual content, etc.) that may be associated with confidential content, e.g., the top-secret document 344 in window 334, the graphic in window 336, or the notification in window 338.

Based on the confidentiality level of the second participant 306, it may be determined that the second participant 306 is not authorized to view such content. In this case, the same or another multimodal ML model may apply an appropriate modification to the detected confidential content to prevent disclosure. As illustrated, textual content of the top-secret document 344 has been modified to pseudo text 340, content of the graphic has been replaced by wavy lines 342, and textual content of notification 338 has been replaced by wavy lines 346. In this way, even if a desktop is inadvertently shared, the described technology prevents disclosure of confidential content. In aspects, the modifications made to detected confidential content described above are provided as examples and should not be understood as limitations to the described technology.

FIG. 4A illustrates an overview of an example method 400A for using one or more ML models to detect confidential content associated with a conferencing session according to aspects described herein. In examples, aspects of method 400A are performed by a model orchestrator (e.g., model orchestrator 110 in FIG. 1), by a machine learning framework (e.g., machine learning framework 120), and/or by a machine learning interface (e.g., machine learning interface 128), among other examples.

As illustrated, method 400 begins at access operation 402, where a library of confidential content is accessed by a model orchestrator, for example, for a particular user or enterprise. For example, the library may be built for the user or enterprise over time and may include, without limitation, terms (e.g., previous project names, naming conventions associated with confidential projects, organizational confidentiality levels or designations, footer designations of confidentiality), VIP user names or aliases (e.g., CEO, general counsel, human resources employees, or other company officials associated with confidential content), user confidentiality levels (e.g., organizational low, medium, high, VIP levels, etc.), documents (e.g., pre-launch product specifications, internal presentations, whitepapers), metadata (e.g., file names/titles, authors, file extensions, file types, descriptions, etc., associated with confidential content), images (e.g., blueprints, product prototypes, maps, graphics, diagrams, reports), spreadsheets (e.g., financials, experimental data), links or pointers (e.g., file locations associated with repositories of confidential content), sounds (e.g., spoken terms, names, jingles), and the like, that may be used to train one or more ML models for detecting confidential content specific to an organization or individual. As should be appreciated, confidential content associated with a particular user or an organization may be designated via any suitable means and the foregoing list is provided for purposes of example and should not be considered as limiting in any way.

Additionally, the library may include one or more indications of generic confidential content. For example, some terms (e.g., “confidential,” “proprietary,” “attorney eyes only,” “do not forward”), number formatting (e.g., indicative of Social Security Numbers, Driver's License Numbers, phone numbers), file extensions (e.g., “.dwg” for AutoCAD; “.stl,” “.obj,” “.fbx,” “.dae” for 3D printing; “.mat” for MATLAB; “.cdx” for ChemDraw), mathematical conventions (e.g., terms, symbols, format), code languages (e.g., XML, C++, JavaScript®, Python®), and the like, may be indicative of files or documents containing confidential content. In other cases, some terms, images, or sounds may generally be considered inappropriate, offensive, private, or embarrassing may be accessed via the library (e.g., sound of a toilet flushing, sound of belching, sound of an automobile horn, images of private body parts, curse words, pejorative terms, derogatory terms, offensive terms). As should be appreciated, generic examples of confidential or private content may be designated via any suitable means and the foregoing list is provided for purposes of example and should not be considered as limiting in any way.

At train operation 404, one or more ML models of a multimodal ML model may be trained using the library to detect confidential content in a variety of different content types and formats (e.g., audio, video, image, streaming, graphic, text, HTTP, XML, and the like). For example, a first ML model may be trained to detect confidential content in image content, a second ML model may be trained to detect confidential content in audio content, a third ML model may be trained to detect confidential content in video content, and the like. In aspects, the one or more ML models may be trained to detect confidential content in real-time or near real-time. That is, while conference input is being received (e.g., during a video conference), the one or more ML models may be trained to continuously (e.g., frame-by-frame) or periodically (e.g., scheduled intervals, in response to detecting a change, etc.) scan the various content types represented in the conference input for confidential content.

In further aspects, described with respect to FIG. 4B, based on the content type and format of detected confidential content, one or more ML models of the same or different multimodal ML model may be trained to apply an appropriate modification to the detected confidential content to prevent its disclosure. In aspects, the one or more ML models may be trained to apply different modification protocols based on the different content types or formats of the detected confidential content, according to embodiments described herein. For example, a first ML model may be trained to apply a first modification protocol to confidential content in image content, while a second ML model may be trained to apply a second modification protocol to confidential content in audio content. Moreover, the one or more ML models may be trained to apply different modification protocols to detected confidential content based on different contexts. For example, based on a first context, blurring may be applied to image content comprising confidential content, whereas based on a second context, infilling may be applied to image content comprising confidential content. In aspects, the modification protocol applied in different contexts may be user-defined or may be a further aspect of training the one or more ML models, as described herein.

At receive operation 406, conference input may be received by a multimodal ML model. In aspects, during a conferencing session, conference input may be received continuously, e.g., from a conferencing application (e.g., conferencing application 118) and/or a conferencing service (e.g., conferencing service 106). For example, a first conference input may be received at time T1 (e.g., a first frame of a video conference, a first soundbite of an audio conference) and a second conferencing input may be received at time T2 (e.g., a second frame of a video conference, a second soundbite of an audio conference). In examples, a model orchestrator (e.g., model orchestrator 110) of a machine learning service 102 receives the conference input. As another example, a request is provided to the machine learning service to process the conference input, such that an indication of detected confidential content is received in response, as may be the case when aspects of method 400A are performed by a multi-stage machine learning framework of a client computing device (e.g., computing device 104 in FIG. 1). As a further example, at least a part of confidential content detection in the conference input is performed local to the computing device, as may be the case when a generative ML model for performing such aspects is locally available.

At determination operation 408, the received conference input is analyzed to determine at least one content type and/or content format. In some examples, content type and/or content format may be determined based on a file extension of the received conference input. In other aspects, multiple content types may be associated with a particular file extension (e.g., a video having a .mov file extension may comprise audio and image content in multiple different file formats). In some cases, when multiple content types are determined, parallel processing of the conference input may occur by the same or different ML models.

At select operation 410, one or more ML models of a multimodal ML model may be selected for each determined content type and/or format of the received conference input. As described above, the one or more ML models of the multimodal ML model may be trained to detect confidential content in different types of content. For example, a first ML model may be trained to detect confidential content in image content, a second ML model may be trained to detect confidential content in audio content, a third ML model may be trained to detect confidential content in video content, and the like. Accordingly, based on the determined content type and/or format of the received conference input, an appropriate ML model may be selected.

At determination operation 412, it may be determined whether to recall context from a semantic memory store (e.g., semantic memory store 116/124/132 and/or 216 in FIGS. 1 and 2). While examples are described in which a generative ML model is used to detect confidential content in a conference input, a semantic store similar to semantic memory store 216 may additionally, or alternatively, be used to store one or more embeddings associated with confidential content (e.g., as may be generated based on a description, manual page, and/or at least a part of an associated prompt template). For instance, an input embedding may be generated for the conference input that was received at receive operation 406 (e.g., thereby indicating one or more associated intents) and used to identify confidential content having associated embeddings that match the input embedding (similar to aspects discussed above with respect to recall engine 214). As another example, a context may be provided to the generative ML model when detecting confidential content (e.g., which may be included as part of the generated prompt), as may be determined by a recall engine from a semantic memory engine, similar to recall engine 214 and semantic memory store 216 discussed above with respect to FIG. 2.

As discussed above, the determination of whether to recall context may be based on a prompt template. For example, the prompt template may indicate that context should be obtained from the semantic memory store and/or may include an indication as to what context should be obtained, if available. As another example, it may be automatically determined to recall context from the semantic memory store, as may be determined based on previous conference input that used the same or a similar prompt. Thus, it will be appreciated that context may be obtained from a semantic memory store for received conference input as a result of any of a variety of determinations and/or indications, among other examples.

If it is determined to recall context from the semantic memory, flow branches “YES” to generate operation 414, where context is generated based the semantic memory store. Such aspects may be similar to those discussed above with respect to recall engine 214 in FIG. 2 and are therefore not necessarily redescribed in detail below. For example, an input semantic embedding is generated based on the conference input and/or the prompt template for which the ML evaluation is to be performed, such that one or more matching semantic embeddings may be identified from the semantic memory store. Content corresponding to the identified semantic embedding(s) is retrieved and used as context for the ML evaluation of the conference input accordingly. As noted above, the retrieved context may be included in a prompt that is generated according to the prompt template. It will be appreciated that context may be obtained from any of a variety of sources, including, but not limited to, a user's computing device (e.g., computing device 104 in FIG. 1) and/or a machine learning service (e.g., machine learning service 102), among other examples. By contrast, if it is instead determined not to recall context from the semantic memory store, flow instead branches “NO” to detect operation 416, which is discussed below.

At detect operation 416, output is generated by the selected one or more ML models. In aspects, the output corresponds to an indication of confidential content in the conference input. If context is generated at operation 414, a prompt may be generated based on a prompt template, such that the prompt includes at least a part of the conference input and, in some examples, the generated context. It will be appreciated that, in other examples, an ML model may not use prompting. If confidential content is detected, flow branches “YES” to provide operation 418.

At provide operation 418, an indication of generated output (e.g., detected confidential content) is provided. In aspects, the indication of generated output may be provided to the same or different multimodal ML model for further processing, as described with reference to FIG. 4B. In additional or alternative aspects, the indication may be provided to an application (e.g., conferencing application 118 in FIG. 1) or service (e.g., conferencing service 106) for subsequent processing. For example, the application may be programmed to apply modifications to the generated output (e.g., the detected confidential content) to prevent disclosure. In some instances, an indication of at least a part of the generated output is broadcast to a user of the computing device (e.g., to a conference participant). As noted above, the resulting output may include any of a variety of content, including, but not limited to, natural language output, speech and/or audio output, image output, video output, and/or programmatic output. Flow may then proceed to determination operation 420.

If confidential content is not detected, flow branches “NO” to determination operation 420, where it is determined whether a conferencing session associated with the received conference input has ended. If the conferencing session has not ended, flow branches “NO” and returns to receive operation 406 to receive subsequent conference input. If the conferencing session has ended, flow branches “YES” and proceeds to post-conference evaluation operation 422.

At post-conference evaluation operation 422, one or more ML models may be utilized to evaluate post-conference interactions between participants or other users. For example, if a participant records the conference session, the system may monitor whether the participant forwards the recording. If so, one or more ML models may be utilized to evaluate confidentiality levels of the recipients to which the recording is forwarded. Upon determining that a recipient is not authorized to access confidential content in the recording, one or more ML models may be utilized to detect and modify the confidential content in the recording, as described above.

FIG. 4B illustrates an overview of an example method 400B for using one or more ML models to modify confidential content associated with a conferencing session according to aspects described herein. In examples, aspects of method 400B are performed by a model orchestrator (e.g., model orchestrator 110 in FIG. 1), by a machine learning framework (e.g., machine learning framework 120), and/or by a machine learning interface (e.g., machine learning interface 128), among other examples.

As illustrated, method 400B begins at operation 424, where an indication of generated output (e.g., detected confidential content) is received. For example, the indication of detected confidential content may be tagged or otherwise identified in processed conference input. In examples, a model orchestrator (e.g., model orchestrator 110) of a machine learning service 102 receives the indication of detected confidential content. As another example, a request is provided to the machine learning service to process the detected confidential content, such that an indication of modified confidential content is received in response, as may be the case when aspects of method 400B are performed by a multi-stage machine learning framework of a client computing device (e.g., computing device 104 in FIG. 1). As a further example, at least a part of modifying confidential content to prevent disclosure is performed local to the computing device, as may be the case when a generative ML model for performing such aspects is locally available.

At determination operation 426, the received indication of detected confidential content is analyzed to determine at least one content type and/or content format associated with the detected confidential content. Additionally or alternatively, a content type and/or format of the detected confidential content may be provided with the received indication.

At select operation 428, one or more ML models of a multimodal ML model may be selected based on the determined content type and/or format. As described above, one or more ML models of the same or different multimodal ML model as implemented in method 400A may be trained to apply an appropriate modification to the detected confidential content to prevent its disclosure in method 400B. In aspects, the one or more ML models may be trained to apply different modification protocols based on the different content types or formats of the detected confidential content, according to embodiments described herein. For example, a first ML model may be trained to apply a first modification protocol to confidential content in image content, while a second ML model may be trained to apply a second modification protocol to confidential content in audio content. Moreover, the one or more ML models may be trained to apply different modification protocols to detected confidential content based on different contexts. For example, based on a first context, blurring may be applied to image content comprising confidential content, whereas based on a second context, infilling may be applied to image content comprising confidential content. In aspects, the modification protocol applied in different contexts may be user-defined or may be a further aspect of training the one or more ML models, as described herein.

At determination operation 430, it may be determined whether to recall context from a semantic memory store (e.g., semantic memory store 116/124/132 and/or 216 in FIGS. 1 and 2). While examples are described in which a generative ML model is used to modify confidential content in a conference input, a semantic store similar to semantic memory store 216 may additionally, or alternatively, be used to store one or more embeddings associated with modifying confidential content (e.g., as may be generated based on a description, manual page, and/or at least a part of an associated prompt template). For instance, an input embedding may be generated for modifying the confidential content that was received at receive operation 424 (e.g., thereby indicating one or more associated intents) and used to modify confidential content having associated embeddings that match the input embedding (similar to aspects discussed above with respect to recall engine 214). As another example, a context may be provided to the generative ML model for modifying confidential content (e.g., which may be included as part of the generated prompt), as may be determined by a recall engine from a semantic memory engine, similar to recall engine 214 and semantic memory store 216 discussed above with respect to FIG. 2.

As discussed above, the determination of whether to recall context may be based on a prompt template. For example, the prompt template may indicate that context should be obtained from the semantic memory store and/or may include an indication as to what context should be obtained, if available. As another example, it may be automatically determined to recall context from the semantic memory store, as may be determined based on previous confidential content that used the same or a similar prompt. Thus, it will be appreciated that context may be obtained from a semantic memory store for modifying confidential content as a result of any of a variety of determinations and/or indications, among other examples.

If it is determined to recall context from the semantic memory, flow branches “YES” to generate operation 432, where context is generated based the semantic memory store. Such aspects may be similar to those discussed above with respect to recall engine 214 in FIG. 2 and are therefore not necessarily redescribed in detail below. For example, an input semantic embedding is generated based on the detected confidential content and/or the prompt template for which the ML evaluation is to be performed, such that one or more matching semantic embeddings may be identified from the semantic memory store. Content corresponding to the identified semantic embedding(s) is retrieved and used as context for the ML evaluation of the confidential content input accordingly. As noted above, the retrieved context may be included in a prompt that is generated according to the prompt template. It will be appreciated that context may be obtained from any of a variety of sources, including, but not limited to, a user's computing device (e.g., computing device 104 in FIG. 1) and/or a machine learning service (e.g., machine learning service 102), among other examples. By contrast, if it is instead determined not to recall context from the semantic memory store, flow instead branches “NO” to modify operation 434, which is discussed below.

At generate operation 434, output is generated by the selected one or more ML models. In aspects, the output corresponds to a modification to confidential content in the conference input. If context is generated at operation 432, a prompt may be generated based on a prompt template, such that the prompt includes at least a part of the confidential content and, in some examples, the generated context. It will be appreciated that, in other examples, an ML model may not use prompting. In some aspects, the generated output (e.g., a modification to confidential content or a corresponding indication) may be provided to an application (e.g., conferencing application 118 in FIG. 1) or service (e.g., conferencing service 106) for subsequent processing. For example, the application may be programmed to apply modifications to the generated output (e.g., the detected confidential content) to prevent disclosure. In some instances, an indication of at least a part of the generated output is broadcast to a user of the computing device (e.g., to a conference participant). For example, the conferencing application may broadcast modified confidential content to one or more participants of a conferencing session to prevent disclosure of the confidential content. Flow may then proceed to determination operation 436.

At determination operation 436, it is determined whether a conferencing session associated with the received confidential content has ended. If the conferencing session has not ended, flow branches “NO” and returns to receive operation 406 of FIG. 4A to receive subsequent conference input. If the conferencing session has ended, flow branches “YES” and proceeds to post-conference evaluation operation 438.

At post-conference evaluation operation 438, similar to post-conference evaluation operation 422, one or more ML models may be utilized to evaluate post-conference interactions between participants or other users. For example, if a participant records the conferencing session, the system may monitor whether the participant forwards the recording. If so, one or more ML models may be utilized to evaluate confidentiality levels of the recipients to which the recording is forwarded. Upon determining that a recipient is not authorized to access confidential content in the recording, one or more ML models may be utilized to detect and modify the confidential content in the recording, as described above.

FIG. 4C illustrates an overview of an example method 400C for providing a modified conferencing session using one or more ML models to detect and/or modify confidential content associated with a conferencing session according to aspects described herein. In some aspects, example method 400C may be performed at least in part by an application (e.g., conference application 118 of FIG. 1) or a service (e.g., conferencing service 106).

At receive operation 440, an indication of a conferencing session may be received. For instance, an application (e.g., conferencing application 118) may receive an indication that a conferencing session is starting when one or more users initiate a “JOIN” command of a meeting invitation. In other aspects, an application (e.g., a VOIP application) may receive an indication that a conferencing session is started when a user dials a telephone number into an interface provided by the application. In other aspects, an application may receive an indication of a conferencing session when an audio or a video call is received by the application. As should be appreciated, there are multiple ways in which an application may receive an indication of a conferencing session and the described examples should not be understood as limiting to the technology disclosed herein.

At determine operation 442, a user confidentiality level for each participant of the plurality of participants attending a conferencing session may be determined. For example, a first user confidentiality level may be determined for a first participant and a second user confidentiality level may be determined for a second participant of the plurality of participants. In some aspects, a user confidentiality level may be assigned or otherwise designated by an organization for a participant (e.g., organizational low, medium, high, VIP levels, etc.). In other aspects, a user confidentiality level may be assigned based on a relationship (e.g., higher user confidentiality level for family versus friends versus acquaintances). As should be appreciated, user confidentiality levels may be assigned via any suitable means.

At receive operation 444, a conference input for the conferencing session may be received. In some aspects, receive operation 444 is similar to receive operation 406 of FIG. 4A. For example, a conference input may be continuously received by an application (e.g., conferencing application 118) from a conferencing service (e.g., conferencing service 106). That is, a first conference input may be received at time T1 (e.g., a first frame of a video conference, a first soundbite of an audio conference) and a second conferencing input may be received at time T2 (e.g., a second frame of a video conference, a second soundbite of an audio conference). As described above with respect to determine operation 408, the conference input may be associated with one or more types of content (e.g., image content, video content, audio content, etc.).

At evaluate operation 446, the conference input may be evaluated using a multimodal machine learning (ML) model to detect confidential content. In some aspects, one or more portions of confidential content may be detected in the conference input by one or more ML models. In aspects, a multimodal ML model may detect confidential content at least in part as described with respect to operations 408-416 of FIG. 4A. The one or more ML models may then output the detected one or more portions of confidential content to the conferencing application and/or the conferencing service as described with respect to provide operation 418 of FIG. 4A.

At determine operation 448, a content confidentiality level may be determined. A content confidentiality level may be assigned based on one or more criteria, e.g., an importance of the content (e.g., organizationally or personally valuable content), a sensitivity of the content (e.g., content associated with organizational or personal harm if disclosed), a privacy of the content (e.g., content that may be embarrassing if disclosed), or any other means.

At compare operation 450, the user confidentiality level of each participant may be compared to the content confidentiality level of the detected confidential content. In some cases, content confidentially levels may have correspondence with user confidentiality levels. For example, users having a low confidentiality level may have access to content having a low confidentiality level. Whereas users having a high confidentiality level may have access to content having low, medium, or high confidentiality levels. In some examples, the lowest user confidentiality level represented by a participant of the conferencing session may be compared to the content confidentiality level. As should be appreciated, any suitable policy or protocol for assigning user and/or content confidentiality levels may be implemented in accordance with the present technology.

At generate operation 452, a modified (e.g., cloaked) conference output may be generated. The cloaked conference output may be generated by modifying the detected confidential content to prevent disclosure. For example, for at least a first participant having a lower user confidentiality level than the content confidentiality level of the detected confidential content, the detected confidential content may be obscured or otherwise modified to prevent disclosure to the first participant. For example, one or more ML models may be trained to apply different modification protocols based on the different content types or formats of the detected confidential content to prevent disclosure, as described with respect to operations 426-434 of FIG. 4B. In aspects, the cloaked conference output may be different for different participants based on differing confidentiality levels of the participants. For example, some content that is detected as confidential content and modified to prevent disclosure to one participant may not be identified as confidential content and/or modified for another participant and vice versa. That is, based on a first user confidentiality level for a first participant, a first modified (e.g., cloaked) conference output may be generated by automatically modifying a first portion of the detected confidential content. Based on a second user confidentiality level for a second participant, a second modified (e.g., cloaked) conference output may be generated by automatically modifying a second portion of the detected confidential content. In another example, when the lowest user confidentiality level for the conferencing session is compared to the content confidentiality level, a single modified (e.g., cloaked) conference output may be generated for all participants.

At broadcast operation 454, the cloaked conference output may be broadcast to the first participant having a lower user confidentiality level than the content confidentiality level. In aspects, the conferencing application and/or the conferencing service may broadcast the cloaked conference output. As noted above, for participants having different confidentiality levels, the user experience during a conferencing session may differ to ensure that confidential content is not disclosed to those without adequate permissions. For example, based on a first user confidentiality level, a first cloaked conference output may be broadcast to a first participant and, based on a second user confidentiality level, a second cloaked conference output may be broadcast to a second participant for the same conferencing session. In other examples, a single cloaked conference output may be broadcast to all of the participants based on the lowest user confidentiality level represented by participant(s) of the conferencing session.

FIGS. 5A and 5B illustrate overviews of an example generative machine learning model that may be used according to aspects described herein. With reference first to FIG. 5A, conceptual diagram 500 depicts an overview of pre-trained generative model package 504 that processes a conference input 502 and, for example, a prompt, to generate model output 506 associated with detecting confidential content, according to aspects described herein. Examples of pre-trained generative model package 504 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 504 is pre-trained according to a variety of inputs (e.g., a variety of human languages, a variety of programming languages, and/or a variety of content types) and therefore need not be finetuned or trained for a specific scenario. Rather, generative model package 504 may be more generally pre-trained, such that conference input 502 includes a prompt that is generated, selected, or otherwise engineered to induce generative model package 504 to produce certain generative model output 506. For example, a prompt includes a context and/or one or more completion prefixes that thus preload generative model package 504 accordingly. As a result, generative model package 504 is induced to generate output based on the prompt that includes a predicted sequence of tokens (e.g., up to a token limit of generative model package 504) relating to the prompt. In examples, the predicted sequence of tokens is further processed (e.g., by output decoding 516) to yield generative model output 506. For instance, each token is processed to identify a corresponding word, word fragment, or other content that forms at least a part of generative model output 506. It will be appreciated that conference input 502 and generative model output 506 may each include any of a variety of content types, including, but not limited to, text output, image output, audio output, video output, programmatic output, and/or binary output, among other examples. In examples, conference input 502 and generative model output 506 may have different content types, as may be the case when generative model package 504 includes a generative multimodal machine learning model.

As such, generative model package 504 may be used in any of a variety of scenarios and, further, a different generative model package may be used in place of generative model package 504 without substantially modifying other associated aspects (e.g., similar to those described herein with respect to FIGS. 1, 2, 3A-3D, and 4A-4C). Accordingly, generative model package 504 operates as a tool with which machine learning processing is performed, in which certain inputs to generative model package 504 are programmatically generated or otherwise determined, thereby causing generative model package 504 to produce model output 506 that may subsequently be used for further processing.

Generative model package 504 may be provided or otherwise used according to any of a variety of paradigms. For example, generative model package 504 may be used local to a computing device (e.g., computing device 104 in FIG. 1) or may be accessed remotely from a machine learning service (e.g., machine learning service 102). In other examples, aspects of generative model package 504 are distributed across multiple computing devices. In some instances, generative model package 504 is accessible via an application programming interface (API), as may be provided by an operating system of the computing device 104 and/or by the machine learning service 102, among other examples.

With reference now to the illustrated aspects of generative model package 504, generative model package 504 includes input tokenization 508, input embedding 510, model layers 512, output layer 514, and output decoding 516. In examples, input tokenization 508 processes conference input 502 to generate input embedding 510, which includes a sequence of symbol representations that corresponds to conference input 502. Accordingly, input embedding 510 is processed by model layers 512, output layer 514, and output decoding 516 to produce model output 506. An example architecture corresponding to generative model package 504 is depicted in FIG. 5B, which is discussed below in further detail. Even so, it will be appreciated that the architectures that are illustrated and described herein are not to be taken in a limiting sense and, in other examples, any of a variety of other architectures may be used.

FIG. 5B is a conceptual diagram that depicts an example architecture 550 of a pre-trained generative machine learning model that may be used according to aspects described herein. As noted above, any of a variety of alternative architectures and corresponding ML models may be used in other examples without departing from the aspects described herein.

As illustrated, architecture 550 processes conference input 502 to produce generative model output 506, aspects of which were discussed above with respect to FIG. 5A. Architecture 550 is depicted as a transformer model that includes encoder 552 and decoder 554. Encoder 552 processes input embedding 558 (aspects of which may be similar to input embedding 510 in FIG. 5A), which includes a sequence of symbol representations that corresponds to input 556. In examples, input 556 includes conference input 502 and a prompt, aspects of which may be similar to conference input 202, context from semantic memory store 216, and/or a prompt that was generated based on a prompt template of a library 114/122/130, and/or 212 according to aspects described herein.

Further, positional encoding 560 may introduce information about the relative and/or absolute position for tokens of input embedding 558. Similarly, output embedding 574 includes a sequence of symbol representations that correspond to output 572, while positional encoding 576 may similarly introduce information about the relative and/or absolute position for tokens of output embedding 574.

As illustrated, encoder 552 includes example layer 570. It will be appreciated that any number of such layers may be used, and that the depicted architecture is simplified for illustrative purposes. Example layer 570 includes two sub-layers: multi-head attention layer 562 and feed forward layer 566. In examples, a residual connection is included around each layer 562, 566, after which normalization layers 564 and 568, respectively, are included.

Decoder 554 includes example layer 590. Similar to encoder 552, any number of such layers may be used in other examples, and the depicted architecture of decoder 554 is simplified for illustrative purposes. As illustrated, example layer 590 includes three sub-layers: masked multi-head attention layer 578, multi-head attention layer 582, and feed forward layer 586. Aspects of multi-head attention layer 582 and feed forward layer 586 may be similar to those discussed above with respect to multi-head attention layer 562 and feed forward layer 566, respectively. Additionally, masked multi-head attention layer 578 performs multi-head attention over the output of encoder 552 (e.g., output 572). In examples, masked multi-head attention layer 578 prevents positions from attending to subsequent positions. Such masking, combined with offsetting the embeddings (e.g., by one position, as illustrated by multi-head attention layer 582), may ensure that a prediction for a given position depends on known output for one or more positions that are less than the given position. As illustrated, residual connections are also included around layers 578, 582, and 586, after which normalization layers 580, 584, and 588, respectively, are included.

Multi-head attention layers 562, 578, and 582 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 5B (e.g., by a corresponding normalization layer 564, 580, or 584).

Feed forward layers 566 and 586 may each be a fully connected feed-forward network, which applies to each position. In examples, feed forward layers 566 and 586 each include a plurality of linear transformations with a rectified linear unit activation in between. In examples, each linear transformation is the same across different positions, while different parameters may be used as compared to other linear transformations of the feed-forward network.

Additionally, aspects of linear transformation 592 may be similar to the linear transformations discussed above with respect to multi-head attention layers 562, 578, and 582, as well as feed forward layers 566 and 586. Softmax 594 may further convert the output of linear transformation 592 to predicted next-token probabilities, as indicated by output probabilities 596. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 504 in FIG. 5A or encoder 552 and decoder 554 in FIG. 5B) to generate a series of output tokens (e.g., words), for example which are then combined to yield a complete sentence (and/or any of a variety of other content). It will be appreciated that other generative models may generate multiple output tokens in a single iteration and may thus used a reduced number of iterations or a single iteration.

Accordingly, output probabilities 596 may thus form confidential content output 506 according to aspects described herein, such that the output of the generative ML model (e.g., which may include structured output) is used as input for subsequent processing (e.g., similar to method 400B of FIG. 4B) according to aspects described herein. In other examples, confidential content output 506 is provided as generated output after processing conference input (e.g., similar to aspects of provide operation 416 of method 400A), which may further be processed according to the disclosed aspects.

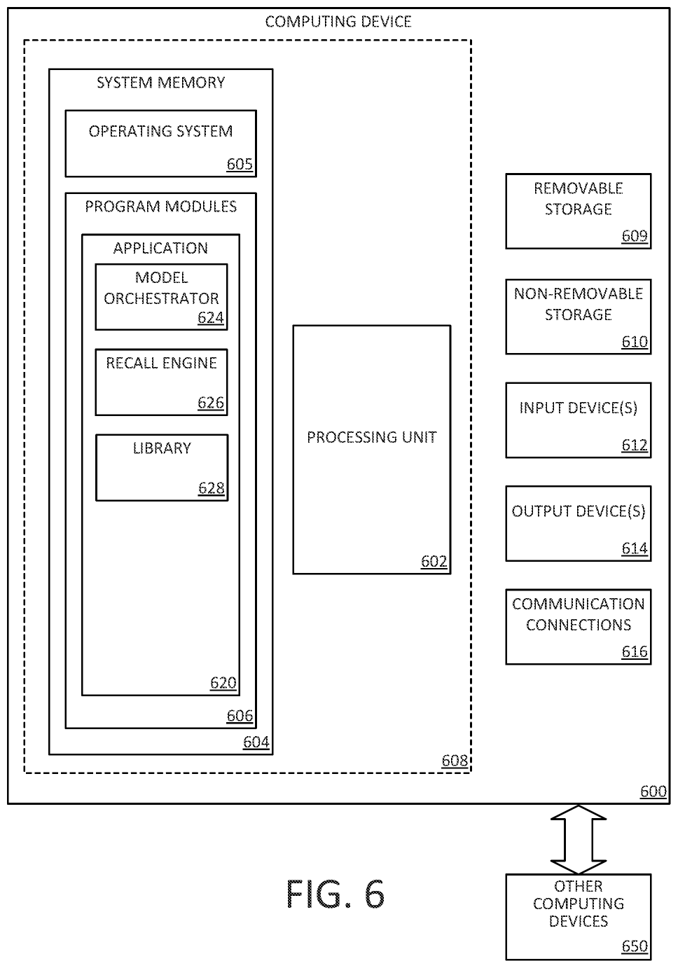

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein.

FIG. 6 is a block diagram illustrating physical components (e.g., hardware) of a computing device 600 with which aspects of the disclosure may be practiced. The computing device components described below may be suitable for the computing devices described above, including one or more devices associated with machine learning service 102, as well as computing device 104 discussed above with respect to FIG. 1. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories.

The system memory 604 may include an operating system 605 and one or more program modules 606 suitable for running software application 620, such as one or more components supported by the systems described herein. As examples, system memory 604 may model orchestrator 624, recall engine 626, and library 628. The operating system 605, for example, may be suitable for controlling the operation of the computing device 600.

Furthermore, embodiments of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 (e.g., application 620) may perform processes including, but not limited to, the aspects, as described herein. Other program modules that may be used in accordance with aspects of the present disclosure may include conferencing applications, conferencing services, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

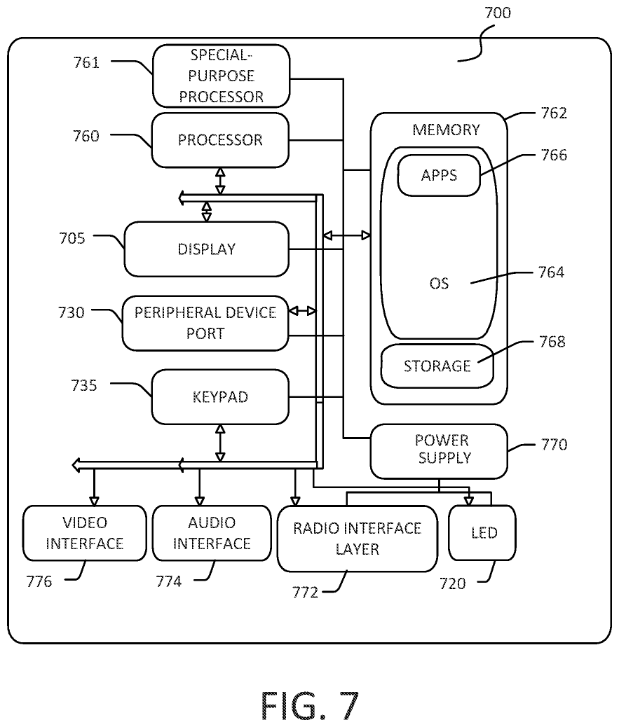

FIG. 7 illustrates a system 700 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 700 is implemented as a “smart phone” capable of running one or more applications (e.g., browser, e-mail, calendaring, contact managers, messaging clients, games, and media clients/players). In some aspects, the system 700 is integrated as a computing device, such as an integrated personal digital assistant (PDA) and wireless phone.

In a basic configuration, such a mobile computing device is a handheld computer having both input elements and output elements. The system 700 typically includes a display 705 and one or more input buttons that allow the user to enter information into the system 700. The display 705 may also function as an input device (e.g., a touch screen display).

If included, an optional side input element allows further user input. For example, the side input element may be a rotary switch, a button, or any other type of manual input element. In alternative aspects, system 700 may incorporate more or less input elements. For example, the display 705 may not be a touch screen in some embodiments. In another example, an optional keypad 735 may also be included, which may be a physical keypad or a “soft” keypad generated on the touch screen display.

In various embodiments, the output elements include the display 705 for showing a graphical user interface (GUI), a visual indicator (e.g., a light emitting diode 720), and/or an audio transducer 725 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 700 also includes a non-volatile storage area 768 within the memory 762. The non-volatile storage area 768 may be used to store persistent information that should not be lost if the system 700 is powered down. The application programs 766 may use and store information in the non-volatile storage area 768, such as e-mail or other messages used by an e-mail application, and the like. A synchronization application (not shown) also resides on the system 700 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the system 700 described herein.

The system 700 has a power supply 770, which may be implemented as one or more batteries. The power supply 770 might further include an external power source, such as an AC adapter or a powered docking cradle that supplements or recharges the batteries.

The system 700 may also include a radio interface layer 772 that performs the function of transmitting and receiving radio frequency communications. The radio interface layer 772 facilitates wireless connectivity between the system 700 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated embodiment, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 700 may further include a video interface 776 that enables an operation of an on-board camera 730 to record still images, video stream, and the like.

It will be appreciated that system 700 may have additional features or functionality. For example, system 700 may also include additional data storage devices (removable and/or non-removable) such as, magnetic disks, optical disks, or tape. Such additional storage is illustrated in FIG. 7 by the non-volatile storage area 768.

Data/information generated or captured and stored via the system 700 may be stored locally, as described above, or the data may be stored on any number of storage media that may be accessed by the device via the radio interface layer 772 or via a wired connection between the system 700 and a separate computing device associated with the system 700, for example, a server computer in a distributed computing network, such as the Internet. As should be appreciated, such data/information may be accessed via the radio interface layer 772 or via a distributed computing network. Similarly, such data/information may be readily transferred between computing devices for storage and use according to any of a variety of data/information transfer and storage means, including electronic mail and collaborative data/information sharing systems.

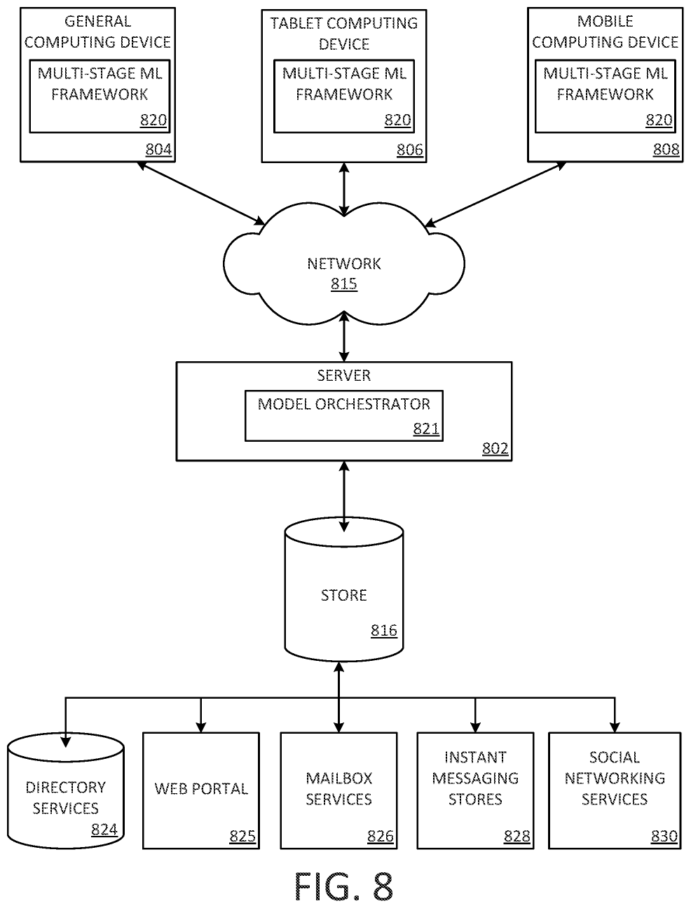

FIG. 8 illustrates one aspect of the architecture of a system for processing data received at a computing system from a remote source, such as a personal computer 804, tablet computing device 806, or mobile computing device 808, as described above. Content displayed at server device 802 may be stored in different communication channels or other storage types. For example, various documents may be stored using a directory service 824, a web portal 825, a mailbox service 826, an instant messaging store 828, or a social networking site 830.

A multi-stage machine learning framework 820 (e.g., similar to application 620) may be employed by a client that communicates with server device 802. Additionally, or alternatively, model orchestrator 821 may be employed by server device 802. The server device 802 may provide data to and from a client computing device such as a personal computer 804, a tablet computing device 806 and/or a mobile computing device 808 (e.g., a smart phone) through a network 815. By way of example, the computer system described above may be embodied in a personal computer 804, a tablet computing device 806 and/or a mobile computing device 808 (e.g., a smart phone). Any of these examples of the computing devices may obtain content from the store 816, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations.

In an aspect, a system including at least one processor and memory storing instructions that, when executed by the at least one processor, cause the system to perform a set of operations is provided. The set of operations include receiving an indication of a conferencing session having a plurality of participants and determining a user confidentiality level associated with each participant of the plurality of participants. The set of operations further includes receiving a first conference input associated with the conferencing session, where the first conference input includes at least a first content type. Based on the first content type, the operations include evaluating the first conference input using a multimodal machine learning (ML) model to detect first confidential content. Additionally, the operations include determining a first content confidentiality level associated with the detected first confidential content and comparing the user confidentiality level of each participant to the first content confidentiality level. Based on the comparing, the operations include generating a first cloaked conference output by automatically modifying the detected first confidential content in the first conference input and broadcasting the first cloaked conference output to at least a first participant having a lower user confidentiality level than the first content confidentiality level.

In aspects of the system described above, the set of operations further include broadcasting the first conference input to at least a second participant having a higher or equal user confidentiality level than the first content confidentiality level, where the first conference input is broadcast unmodified. Additionally, with respect to the system, where the first conference input comprises at least a second content type, and where the multimodal ML model evaluates the first conference input based on the first content type and the second content type to detect the first confidential content. Further, with respect to the system, where the first content type is an audio content type, and where modifying the first conference input comprises obscuring audio data associated with the detected first confidential content. In another aspect, where the first content type is a video content type, and where modifying the first conference input comprises obscuring image data associated with the detected first confidential content. In yet another aspect, where obscuring the image data comprises infilling pixel data associated with the detected first confidential content to match proximal pixel data of the first conference input. In a further aspect, where obscuring the image data comprises blurring pixel data associated with the detected first confidential content. Additionally, in an aspect, where the first content type and the second content type are different.

In further aspects of the system described above, the set of operations include receiving a second conference input associated with the conferencing session, where the second conference input is received after the first conference input and evaluating the second conference input using the multimodal ML model to detect second confidential content. Additionally, the operations include determining a second content confidentiality level associated with the detected second confidential content and comparing the user confidentiality level of each participant to the second content confidentiality level. The operations further include generating a second cloaked conference output by automatically modifying the detected second confidential content in the second conference input and broadcasting the second cloaked conference output to at least a second participant having a lower user confidentiality level than the second content confidentiality level. Additionally, where the second conference input comprises a third content type.

In further aspects of the system described above, where the user confidentiality level of each participant is indicated in an invitation to the conferencing session. Additionally, where automatically modifying the detected first confidential content in the first conference input occurs in near real-time. In further aspects, where automatically modifying the detected first confidential content is performed by the multimodal ML model. In still further aspects, where automatically modifying the detected first confidential content is performed by a different multimodal ML model.

In another aspect, a method of preventing disclosure of confidential content in a conferencing session is provided. The method includes receiving an indication of a conferencing session having a plurality of participants and determining a first user confidentiality level for a first participant and a second user confidentiality level for a second participant of the plurality of participants. The method further includes receiving a conference input associated with the conferencing session and evaluating the conference input using a multimodal machine learning (ML) model to detect one or more portions of confidential content. Based on the first user confidentiality level, the method includes generating a first modified conference output by automatically modifying a first portion of the detected confidential content. Based on the second user confidentiality level, the method includes generating a second modified conference output by automatically modifying a second portion of the detected confidential content and broadcasting the first modified conference output to the first participant and the second modified conference output to the second participant.

In further aspects of the method, where the first portion of detected confidential content is associated with a first content type and the second portion of detected confidential content is associated with a second content type. Additionally, where automatically modifying the first portion of detected confidential content is performed by a first ML model of the multimodal ML model, and where automatically modifying the second portion of detected confidential content is performed by a second ML model of the multimodal ML model. In still further aspects of the method, where a first modification protocol is applied by the multimodal ML model to automatically modify the first portion of detected confidential content, and where a second modification protocol is applied by the multimodal ML model to automatically modify the second portion of detected confidential content.

In yet another aspect, a method of preventing disclosure of confidential content is provided. The method includes receiving a conference input associated with a conferencing session having a plurality of participants and determining a user confidentiality level associated with each participant of the plurality of participants. The method further includes evaluating the conference input using a multimodal machine learning (ML) model to detect confidential content and determining a content confidentiality level associated with the detected confidential content. Additionally, the method includes comparing the user confidentiality level of each participant to the content confidentiality level and based on the comparing, generating a modified conference output by automatically modifying the detected confidential content in the conference input. In further aspects, the method includes broadcasting the modified conference output to at least one participant having a lower user confidentiality level than the content confidentiality level. In further aspects, where the conference input comprises at least one content type, and where the multimodal ML model evaluates the conference input based on the at least one content type to detect the confidential content.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
receiving an indication of a conferencing session having a plurality of participants;
determining a user confidentiality level associated with each participant of the plurality of participants;
receiving a first conference input associated with the conferencing session, wherein the first conference input includes at least a first content type;
based on the first content type, evaluating the first conference input using a multimodal machine learning (ML) model to detect first confidential content;
determining a first content confidentiality level associated with the detected first confidential content;
comparing the user confidentiality level of each participant to the first content confidentiality level;
based on the comparing, generating a first cloaked conference output by automatically modifying the detected first confidential content in the first conference input; and
broadcasting the first cloaked conference output to at least a first participant having a lower user confidentiality level than the first content confidentiality level.

2. The system of claim 1, further comprising:
broadcasting the first conference input to at least a second participant having a higher or equal user confidentiality level than the first content confidentiality level, wherein the first conference input is broadcast unmodified.

3. The system of claim 1, wherein the first conference input comprises at least a second content type, and wherein the multimodal ML model evaluates the first conference input based on the first content type and the second content type to detect the first confidential content.

4. The system of claim 1, wherein the first content type is an audio content type, and wherein modifying the first conference input comprises obscuring audio data associated with the detected first confidential content.

5. The system of claim 1, wherein the first content type is a video content type, and wherein modifying the first conference input comprises obscuring image data associated with the detected first confidential content.

6. The system of claim 5, wherein obscuring the image data comprises infilling pixel data associated with the detected first confidential content to match proximal pixel data of the first conference input.

7. The system of claim 5, wherein obscuring the image data comprises blurring pixel data associated with the detected first confidential content.

8. The system of claim 3, wherein the first content type and the second content type are different.

9. The system of claim 1, further comprising:
receiving a second conference input associated with the conferencing session, wherein the second conference input is received after the first conference input;
evaluating the second conference input using the multimodal ML model to detect second confidential content;
determining a second content confidentiality level associated with the detected second confidential content;
comparing the user confidentiality level of each participant to the second content confidentiality level;
generating a second cloaked conference output by automatically modifying the detected second confidential content in the second conference input; and
broadcasting the second cloaked conference output to at least a second participant having a lower user confidentiality level than the second content confidentiality level.

10. The system of claim 9, wherein the second conference input comprises a third content type.

11. The system of claim 1, wherein the user confidentiality level of each participant is indicated in an invitation to the conferencing session.

12. The system of claim 1, wherein automatically modifying the detected first confidential content in the first conference input occurs in near real-time.

13. The system of claim 1, wherein automatically modifying the detected first confidential content is performed by the multimodal ML model.

14. The system of claim 1, wherein automatically modifying the detected first confidential content is performed by a different multimodal ML model.

15. A method of preventing disclosure of confidential content in a conferencing session, comprising:
receiving an indication of a conferencing session having a plurality of participants;
determining a first user confidentiality level for a first participant and a second user confidentiality level for a second participant of the plurality of participants;
receiving a conference input associated with the conferencing session;
evaluating the conference input using a multimodal machine learning (ML) model to detect one or more portions of confidential content;
based on the first user confidentiality level, generating a first modified conference output by automatically modifying a first portion of the detected confidential content;
based on the second user confidentiality level, generating a second modified conference output by automatically modifying a second portion of the detected confidential content; and
broadcasting the first modified conference output to the first participant and the second modified conference output to the second participant.

16. The method of claim 15, wherein the first portion of detected confidential content is associated with a first content type and the second portion of detected confidential content is associated with a second content type.

17. The method of claim 16, wherein automatically modifying the first portion of detected confidential content is performed by a first ML model of the multimodal ML model, and wherein automatically modifying the second portion of detected confidential content is performed by a second ML model of the multimodal ML model.

18. The method of claim 16, wherein a first modification protocol is applied by the multimodal ML model to automatically modify the first portion of detected confidential content, and wherein a second modification protocol is applied by the multimodal ML model to automatically modify the second portion of detected confidential content.

19. A method of preventing disclosure of confidential content, comprising:
receiving a conference input associated with a conferencing session having a plurality of participants;
determining a user confidentiality level associated with each participant of the plurality of participants;
evaluating the conference input using a multimodal machine learning (ML) model to detect confidential content;
determining a content confidentiality level associated with the detected confidential content;
comparing the user confidentiality level of each participant to the content confidentiality level;
based on the comparing, generating a modified conference output by automatically modifying the detected confidential content in the conference input; and
broadcasting the modified conference output to at least one participant having a lower user confidentiality level than the content confidentiality level.

20. The method of claim 19, wherein the conference input comprises at least one content type, and wherein the multimodal ML model evaluates the conference input based on the at least one content type to detect the confidential content.
